(19) United States
(12) Patent Application Publication
(10) Pub. No.: US 2020/0158269 A1
(43) Pub. Date: May 21, 2020

(54) EXTENSIBLE AND RETRACTABLE HOSE

(71) Applicant: Mordechai Perlmutter, Spring Valley, NY (US)

(72) Inventor: Mordechai Perlmutter, Spring valley, NY (US)

(21) Appl. No.: 16/197,262

(22) Filed: Nov. 20, 2018

(51) Int. Cl. F16L 11/11

(52) U.S. Cl. CPC F16L 11/11; F16L 11/16

(57) ABSTRACT

The present disclosure provides a leak-proof hose for transportation of fluids therein. The hose comprises an elastic tube with a first end portion and a second end portion. The hose also comprises an extensible cylindrical housing with a first end and a second end, and arranged to substantially accommodate a length of the elastic tube co-axially inside thereof. The hose further comprises a coupling member positioned at the first end of the extensible cylindrical housing. The coupling member have external threads adapted to allow removably attaching of an attachment device therewith. In the present hose, at least the first end portion of the elastic tube is extending outside of the first end of the extensible cylindrical housing and is folded over the coupling member.

### II. BACKGROUND OF THE INVENTION

### 1. Field of the Invention

The present disclosure relates generally to hoses for transporting fluid materials, and more specifically, to a flexible hose that can extend and retract with little to no leaking when a pressurized fluid is introduced into the hose.

### 2. Description of the Related Art

Hoses are well known in the art for transporting fluid materials from one place to another. Conventional garden hoses are traditionally composed of rubber or other resilient flexible materials such as thermoplastic rubber, synthetic rubber, or the like. Hoses constructed in this manner typically pose problems in relation to storage and manipulation. Although hose is flexible and can be wound on a cylinder or drum in storage and transport, this does not reduce the length and width of the hose which may warrant large storage space. Another problem is wound or coiled hose is prone to kinking or volume when open. The average homeowner using a garden hose to their grasslands often encounter this problem when watering plants or washing their vehicles.

Expandable hoses have been developed to solve the storage and manipulation problems users were having with conventional hoses. For instance, some hoses have been designed which resort to a contracted state automatically, when pressurized fluid is not present therein; and the hose automatically extended to an extended or expanded state, when the pressurized fluid is introduced therein. In the contracted state, the hose has relatively short length and a relatively light weight, as compared to the extended state thereof. Therefore, the hose may become relatively easy to store and easier to manipulate.

For instance, U.S. Pat. No. 4,009,734 discloses a flexible tube wound from shrinkage, the tube having a desired strength and elastic memory rewinding. Wound tubes are particularly useful as the fluid under pressure to a pneumatic device autogenous shrinkage trachea. Wound tube comprising an extruded seamless plastic tubing, seamless plastic tubing which is expanded by extruding a polyester comprising chemically about 10% to about 50% of a mixture of poly (butylene terephthalate) polymer produced.

Another example is U.S. Pat. No. 4,989,643 which discloses a high performance composite tube, the composite tube having enhanced durability, reliability and a long life cycle for high pressure, high temperature and/or fluctuating environment, such as a turbocharger trucks, buses, motor vehicles, ships and engines. The composite hose comprising one or more layers equalization fabric, the fabric has adhered to the inner surface of each fabric layer and the outer surface of the high performance elastomer.

Yet another example is U.S. Pat. No. 5,036,890 which discloses a device which may be plugged into a conventional garden hose or the end of the hydrant, means for, in use, the hose is easily applied by the tension in the hose results in the fire local hose plug end of the bent portion due to kinks and breakage of the reinforcement. Reinforcing means comprises a coiled section of an elastic material, one end of which is mounted an elastic washer hose can be freely inserted or removed from the hose.

However, a problem that is now prevalent in the expandable garden hose realm is those hoses' propensity to leak at the fluid entry and exit points, where generally one or more attachments may be connected therewith. Therefore, a solution is needed to provide a hose that is compactable for convenient storage, flexible for easy manipulation, and sturdily constructed in a novel manner to avoid leaking at the fluid entry and exit points. Documents describing the closest subject matter provide for a number of more or less complicated features that fail to solve the problems described above in an efficient and economical way. None of the documents suggest the novel features of the present disclosure.

### III. SUMMARY OF THE INVENTION

It is one of the main objectives of the present disclosure to provide a hose which is able to extend and retract based on fluid pressure applied to the hose.

It is another objective of the present disclosure to provide a hose with little to no leaking when a pressurized fluid is introduced into the hose.

It is yet another objective of the present disclosure to provide a hose which allows removably attaching of an attachment device therewith.

In one aspect, the present disclosure provides a hose comprising an elastic tube with a first end portion and a second end portion. The hose also comprises an extensible cylindrical housing with a first end and a second end, and arranged to substantially accommodate a length of the elastic tube co-axially inside thereof. The hose further comprises a coupling member positioned at the first end of the extensible cylindrical housing. The coupling member have external threads adapted to allow removably attaching of an attachment device therewith. At least the first end portion of the elastic tube is extending outside of the first end of the extensible cylindrical housing and is folded over the coupling member.

In one or more embodiments, the hose further comprises a clamping member arranged over the folded first end portion of the elastic tube and tightened against the coupling member underneath thereof.

In one or more embodiments, the hose further comprises a cap member to cover the folded first end portion of the elastic tube and the clamping member.

In one or more embodiments, the hose further comprises another coupling member positioned at the second end of the extensible cylindrical housing. The another coupling member have external threads adapted to allow removably attaching of an attachment device therewith. The second end portion of the elastic tube is extending outside of the second end of the extensible cylindrical housing such that the second end portion of the elastic tube is folded over the another coupling member.

In one or more embodiments, the hose further comprises another clamping member arranged over the folded second end portion of the elastic tube and tightened against the another coupling member underneath thereof.

In one or more embodiments, the hose further comprises another cap member to cover the folded second end portion of the elastic tube and the another clamping member.

In one or more embodiments, the elastic tube is made of water-proof thermoplastic elastomer.

In one or more embodiments, the elastic tube is made of triple layer latex.

In one or more embodiments, the elastic tube is adapted to expand both longitudinally and transversely inside the extensible cylindrical housing.

In one or more embodiments, the extensible cylindrical housing is substantially hollow to allow the length of the elastic tube to be extended therein.

In one or more embodiments, the extensible cylindrical housing is a corrugated pipe.

In one or more embodiments, the extensible cylindrical housing is made of non-elastic material.

In one or more embodiments, the coupling member is made of brass material.

In one or more embodiments, the attachment device has internal threads to mate with the external threads of the coupling member for removably attaching therewith.

In one or more embodiments, the attachment device comprises one of an intermediary valve device, a fluid spigot device and a fluid restrictor device.

In one or more embodiments, the attachment device comprises an intermediary valve device having openings at both ends thereof.

In one or more embodiments, the intermediary valve device is adapted to allow removably attaching of one or more of a fluid spigot device and a fluid restrictor device therewith.

In another aspect, the present disclosure provides a leak-proofing arrangement for an elastic tube with a first end portion and a second end portion.

The leak-proofing arrangement comprises an extensible cylindrical housing with a first end and a second end, and arranged to substantially accommodate a length of the elastic tube co-axially inside thereof. The leak-proofing arrangement also comprises a coupling member positioned at the first end of the extensible cylindrical housing. The coupling member have external threads adapted to allow removably attaching of an attachment device therewith. At least the first end portion of the elastic tube is extending outside of the first end of the extensible cylindrical housing and is folded over the coupling member positioned at the first end of the extensible cylindrical housing.

In one or more embodiments, the leak-proofing arrangement further comprises another coupling member positioned at the second end of the extensible cylindrical housing. The another coupling member have external threads adapted to allow removably attaching of an attachment device therewith. The second end portion of the elastic tube is extending outside of the first end of the extensible cylindrical housing such that the first end portion of the elastic tube is folded over the coupling member positioned at the first end of the extensible cylindrical housing.

In one or more embodiments, the leak-proofing arrangement further comprises a clamping member arranged over the folded first end portion of the elastic tube and tightened against the coupling member underneath thereof, and another clamping member arranged over the folded second end portion of the elastic tube and tightened against the another coupling member underneath thereof.

Further objectives of the invention will be brought out in the following part of the specification, wherein detailed description is for the purpose of fully disclosing the invention without placing any limitations thereon.

### IV. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 illustrates a diagrammatic view of a hose device 10 having a hose 100 and an attachment device 200 shown detached from the hose 100, and depicting a zoomed-in portion 20 of a section of the hose 100, in accordance with one or more embodiments of the present disclosure; and

FIG. 2 illustrates a diagrammatic view of the hose device 10 with the attachment device 200 shown attached to the hose 100 therein, in accordance with one or more embodiments of the present disclosure.

FIGS. 3-5 illustrates a diagrammatic view of the alternative hose attachment 20, in accordance with one or more embodiments of the present disclosure.

### V. DETAILED DESCRIPTION OF THE EMBODIMENTS OF THE INVENTION

Illustrative embodiments of the present disclosure are described below. The following explanation provides specific details for a thorough understanding of and enabling description for these embodiments. One skilled in the art will understand that the invention may be practiced without such details. In some instances, well-known structures, processes and functions have not been shown or described in detail to avoid unnecessarily obscuring the description of the embodiments.

It shall be noted that unless the context clearly requires otherwise, throughout the description, the words “comprise,” “comprising,” “include,” “including,” and the like are to be construed in an inclusive sense as opposed to an exclusive or exhaustive sense; that is to say, in the sense of “including, but not limited to.” Words using the singular or plural number also include the plural or singular number, respectively while adhering to the concepts of the present disclosure. Furthermore, references to “one embodiment” and “an embodiment” are not intended to be interpreted as excluding the existence of additional embodiments that also incorporate the recited features.

The same reference numerals throughout the drawings denote elements having the same or similar function. In the following description of the present disclosure, detailed descriptions of known functions and components incorporated herein shall be omitted when it may make the subject matter of the present disclosure unclear or vague. Unless otherwise defined, all terms including technical and scientific terms used herein have the same meaning as commonly understood by one of ordinary skill in the art to which this invention belongs. When terms used herein discord from the commonly understood meaning, the terms shall be interpreted as defined herein.

The embodiments as described herein are subject to many variations. It is understood that various omissions and substitutions of equivalents are contemplated as circumstances may suggest or render expedient, but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

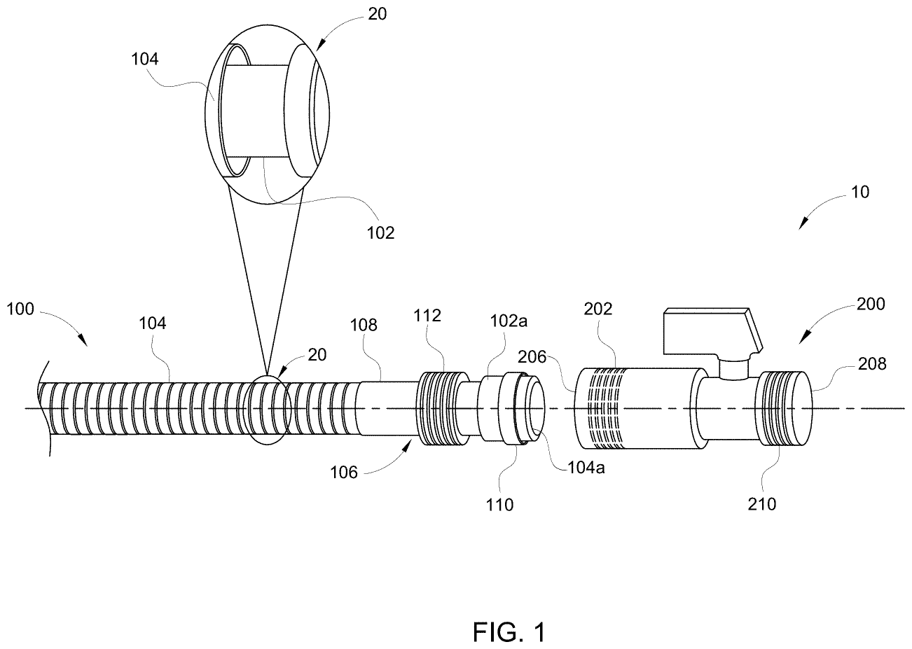

Referring to the drawings, FIG. 1 illustrate a diagrammatic view of a hose device (referred by the numeral 10), in accordance with one or more embodiments of the present disclosure. The hose device 10 includes a hose 100 and an attachment device 200. The hose 100 of the present disclosure is adapted to automatically extend longitudinally and automatically expand laterally upon the application of water pressure as controlled by the attachment device 200, such as a flow restrictor (explained later), positioned along an outlet of the hose 100. The hose 100 may further be adapted to automatically contract upon release of water pressure from within the hose 100. That is, the hose 100 is self-expanding upon the introduction of pressurized water therein, and self-contracting upon release of water therefrom. In one or more examples, the present hose 100 is designed to have the ability to elongate to a length at least three times as great as its unexpanded length with a configuration that prevents fluid leakage at either end of said hose 100. The present hose 100, and thereby the hose device 10, is relatively light compared to a conventional non-expanding/non-contracting hose devices of similar length. The present hose 100 is further adapted to not kink or become entangled upon itself when in use.

The hose 100 includes two separate and distinct members, an inner elastic tube 102 (hereinafter interchangeably referred to as “inner tube”, “elastic tube” and “inner tube member” and the like), and an outer extensible cylindrical housing 104 (hereinafter interchangeably referred to as “outer housing”, “outer tube” and “outer tube member” and the like) which forms part of a leak-proofing arrangement for the inner tube member 102 in the hose 100. In the illustration of FIG. 1, a zoomed-in portion 20 shows a section of the hose 100 depicting the inner tube member 102 being arranged inside the outer tube member 104. The inner tube member 102 is co-axially arranged inside the outer tube member 104. The outer tube member 104 is substantially hollow to allow the length of the inner tube member 102 to be extended therein. It may be understood that the outer tube member 104 is positioned around an outer surface of the inner tube member 102.

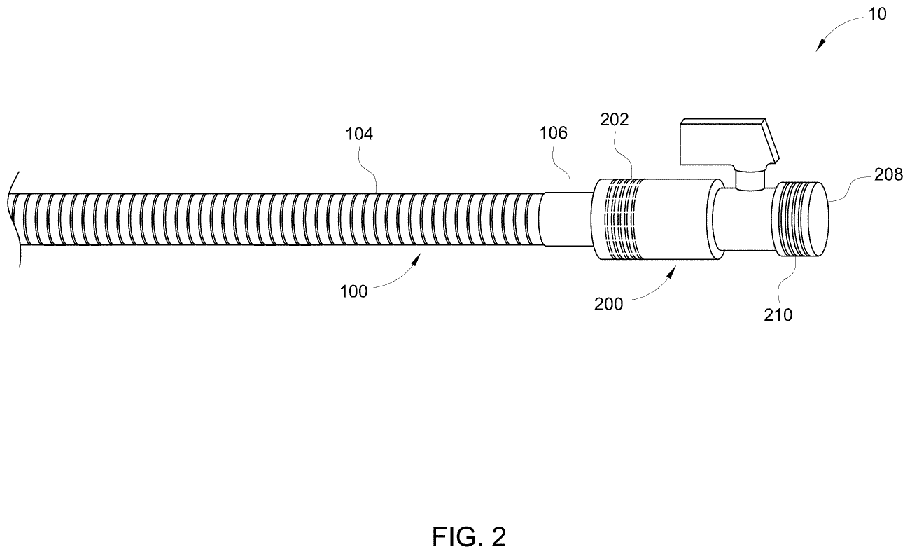

Referring to FIGS. 1-2 in combination, it may be seen the inner tube member 102 has opposing end portions, namely a first end portion 102a and a second end portion (not shown). Also, the outer tube member 104 has opposing ends, namely a first end 104a and a second end (not shown). In the illustrated example, the second end of the outer tube member 104 may be an entry point for fluids entering inner tube member 102 and the first end 104a of the outer tube member 104 may be an exit point for fluids exiting the inner tube member 102. In one or more embodiments of the present disclosure, the outer tube member 104 is generally unsecured, unattached, and unbounded to inner tube member 102 along the length of the inner tube member 102 accommodated therein. In some embodiments, the inner tube member 102 is held in place with respect to the outer tube member 104 by securing of one or more of its end portions therewith, as will be discussed in more detail in the subsequent paragraphs.

In the present examples, the inner tube member 102 is made of water-proof thermoplastic elastomer. In an embodiment, the inner tube member 102 is composed of a thermoplastic elastomer or triple layer latex, although other materials which have elastic properties similar to rubber can also be used without any limitations. Further, in the present examples, the outer tube member 104 is a corrugated pipe. In an embodiment, the tube member 104 is composed of a non-elastic, flexible high polyester self-retracting fabric tubular webbing material. The preferred materials used to form the non-elastic outer tube member 104 are braided or woven nylon, polyester, or polypropylene. Such material for the outer tube member 104 may be soft, bendable, non-elastic, and should be strong enough to withstand high internal pressures.

According to embodiments of the present disclosure, the inner tube member 102 is adapted to expand and retract transversely (or radially) outwardly, and extend/elongate and retract longitudinally (or laterally) inside the outer tube member 104. In one or more examples, the inner tube member 102 is capable of expanding to a length two to six times its unexpanded length. Generally, the expansion of the inner tube member 102 is limited by the maximum diameter of the non-elastic outer tube member 104. In a preferred embodiment of the present invention, fluid pressure within the hose 100 is created in order to lengthen the hose 100 to its fully expanded length. This is accomplished by introducing fluid into one end of the hose 100 and creating pressure within the inner tube member 102 of the hose 100 by restricting the fluid output at other opposite end of the hose 100.

In an embodiment, the present hose device 10 includes a coupling member 106 positioned at the first end 104a of the outer tube member 104. The coupling member 106 may be co-axially attached to a section of the outer tube member 104 at the first end 104a thereof. The coupling member 106 may have a body portion 108 which may generally be cylindrical in shape with inner surface adapted to receive an outer surface of the outer tube member 104. In an example, the coupling member 106 may be attached only to the inner tube member 102 and the outer tube member 104 surrounds the inner tube member 102 but is freely moveable about the length of the inner tube member 102. The coupling member 106 may be designed to be assembled onto the outer tube member 104 without tools. Generally, the coupling member 106 is composed of materials having characteristics associated with metals. In an embodiment, the coupling member 106 is made of brass material. In other examples, the coupling member 106 may be made of plastic material.

According to embodiments of the present disclosure, the first end portion 102a of the inner tube member 102 is extending outside of the first end 104a of the outer tube member 104. Further, as may be seen from FIG. 1, the first end portion 102a of the inner tube member 102 is folded over the coupling member 106, or specifically the body portion 108 of the coupling member 106. Such an arrangement of the present hose 100 with the first end portion 102a of the inner tube member 102 being folded over the coupling member 106 helps to prevent leaking at the coupling site, i.e. the first end 104a of the outer tube member 104. In some examples, the body portion 108 may be insertable into the inner tube member 102, and may have perforations (not shown) to stay inserted in place within inner wall of the inner tube member 102.

In an embodiment, the folded first end portion 102a of the inner tube member 102 is secured to the outer cylindrical body portion 108 of the coupling member 106 by a clamping member 110. The clamping member 110 is arranged over the folded first end portion 102a of the inner tube member 102 and tightened against the coupling member 106 which is positioned underneath thereof. Herein, the clamping member 110 acts as a tightening device for securing the inner tube member 102 with the outer tube member 104. In an example, the clamping member 110 may also be made of metallic material, such as brass (similar to the coupling member 106 against which it is tightened). Further, in one or more embodiments, the hose 100 may include a cap member (not shown) to cover the folded first end portion 102a of the inner tube member 102 and the clamping member 110.

In one or more implementation of the hose device 10, the hose 100 may have the coupling member 106 with external threads 112 formed therein. Specifically, the external threads 112 (or male threaded portion) may be formed on the cylindrical body portion 108 of the coupling member 106. In the present implementations, the external threads 112 are adapted to allow removably attaching of an attachment device (such as, the attachment device 200) therewith. Thus, the coupling member 106 may allow attachment and detachment of the attachment device 200 by just providing manual rotation thereto, without need of any particular tools. For this purpose, the external threads 112 may be of standard configuration based on the implementation. For example, for implementation of the hose device 10 as a garden hose, the external threads 112 may have standard diameter, pitch, etc. to allow for common attachments/accessories associated with the garden hose.

In one or more embodiments, the hose 100 may include another coupling member (not shown), which is generally similar to the coupling member 106. This another coupling member may be positioned at the second end of the outer tube member 104. Such another coupling member may also have external threads (similar to external threads 112 of the coupling member 106) and is adapted to allow removably attaching of another attachment device therewith. In such embodiment, the second end portion of the inner tube member 102 may also be extending outside of the second end of the outer tube member 104 such that the second end portion of the inner tube member 102 is folded over the said another coupling member. Further, the hose 100 may include another clamping member (not shown) arranged over the folded second end portion of the inner tube member 102 and tightened against the another coupling member underneath thereof. In some examples, the hose 100 may also include another cap member (not shown) to cover the folded second end portion of the inner tube member 102 and the another clamping member. Such leak-proofing arrangement for the hose 100 may help to prevent leakage at the opposing second end as well of the outer tube member 104, thereby making the present hose 100 generally resistant to leaking from its entry and exit points.

Further, as illustrated in combination of FIGS. 1-2, the hose device 10 allows coupling of the attachment device 200 with the hose 100. For this purpose, the attachment device 200 has internal threads 202 (or female threaded portion) to mate with the external threads 112 of the coupling member 106 for removably attaching therewith. It may be appreciated that the internal threads 202 of the attachment device 200 may be similar configuration as that of the external threads 112 of the coupling member 106 to be mated therewith. In the present embodiments, the attachment device 200 may be one of an intermediary valve device, a fluid spigot device and a fluid restrictor device.

In the illustrated embodiments, the attachment device 200 has been shown to be the intermediary valve device. Such intermediary valve device or attachment device 200 may have openings, a first opening 206 and a second opening 208, at both ends thereof to allow for entry and exit of fluid from the hose 100. Herein, the intermediary valve device or attachment device 200 may be attached to the coupling member 106 at the first opening 206 (by mating of the internal threads 202) and adapted to allow removably attaching of one or more of a fluid spigot device and a fluid restrictor device therewith at the second opening 208 utilizing threads 210 thereon. In other examples, the fluid spigot device and the fluid restrictor device may be coupled to the coupling member 106 directly without the need of the intermediary valve device without any limitations.

It may be contemplated by a person skilled in the art that the attachment device 200 may act as water restrictor and may even provide an adjustable water restriction means to vary the amount of fluid being able to exit the hose 100 from the first end 104a of the outer tube member 104. Generally, the smaller the opening in water restrictor attachment device 200, the more the attachment device 200 restricts the release of fluid to exit from the hose device 10, and higher the pressure inside the hose 100. Also it may be understood that higher the pressure inside the hose 100, the more expanded the inner tube member 102 becomes. Thus, the hose device 10 of the present disclosure, with the leak-proofing arrangement with folded end portions of the inner tube member 102, helps to keep the coupling sites of the hose 100 therein leak-proof.

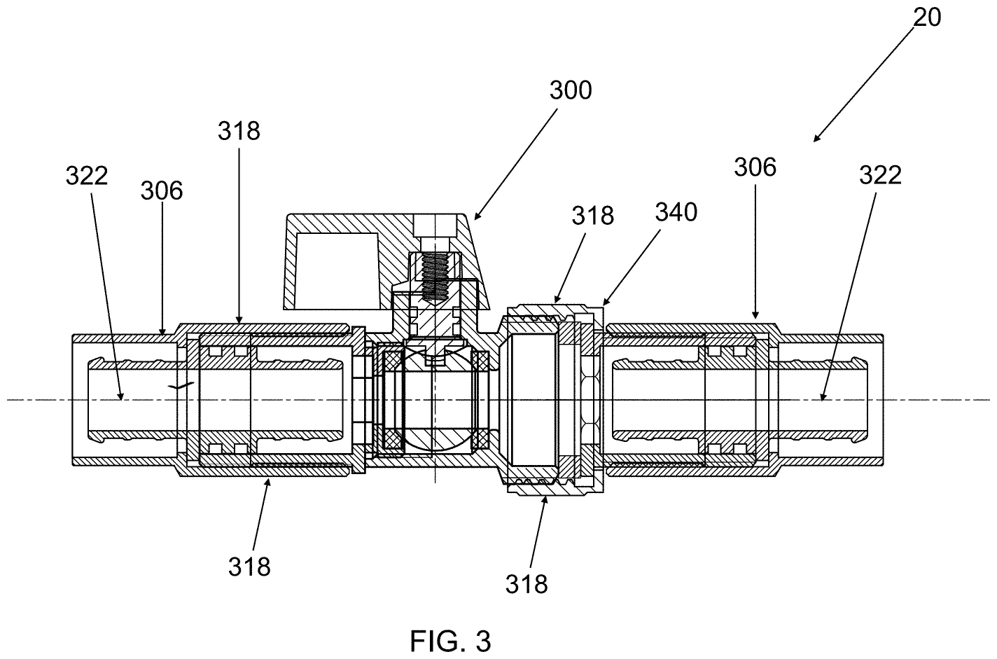

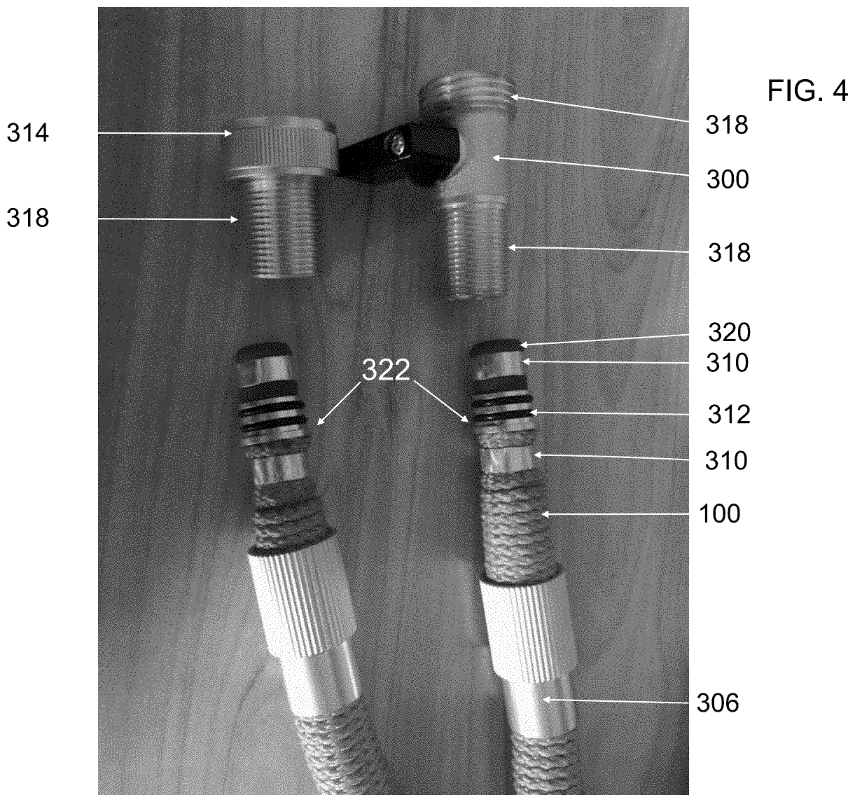

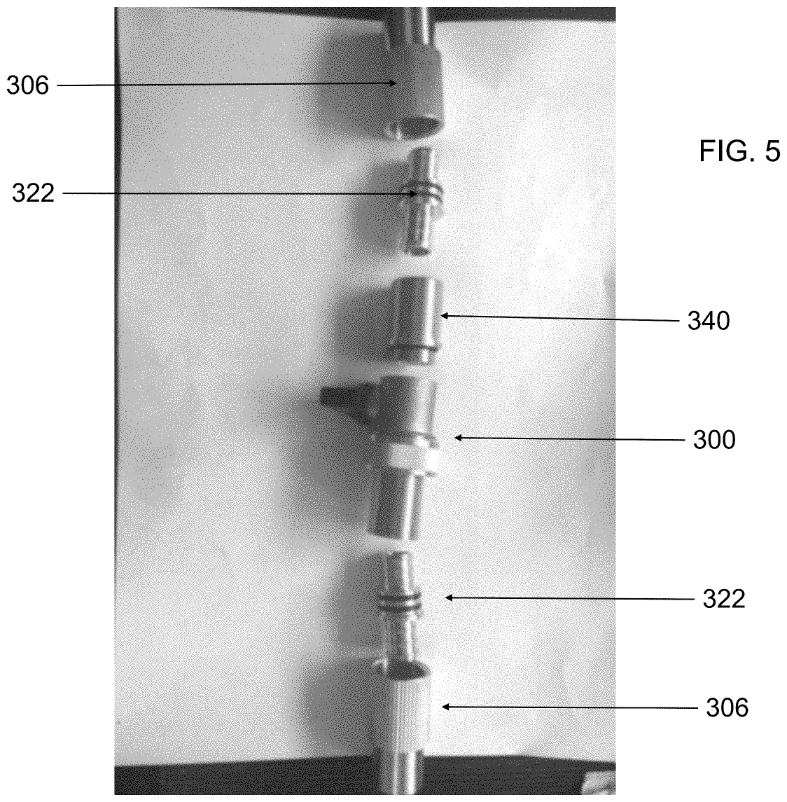

Referring to the drawings, FIGS. 3-5 illustrate views of an alternative hose attachment 20, in accordance with one or more embodiments of the present disclosure. The alternative hose attachment 20 attaches to the hose 100.

In an embodiment, the alternative hose attachment 20 includes a tap 300. There are inner connector tubes 322, that form a watertight seal when coupling member 306 is removably coupled over tap 300 or additional coupler member 340 or end coupler 314 using threads 318. Thus, the coupling member 306 may allow attachment and detachment of the alternative hose attachment 20 by just providing manual rotation thereto, without need of any particular tools.

In addition, to assemble the inner hose 320 is pulled through inner connector 322 and stretched back over the outer surface of inner connector 322. A clamping member 310 holds the inner hose 320 against the inner connector 322. Another clamping member 310 holds the hose 100 against the inner connector 322. Stopper 312 on inner connector 322 provides a tight fit when inserted into coupling member 306, tap 300 or additional coupling member 340.

While the preferred embodiment of the present disclosure has been illustrated and described, as noted above, many changes can be made without departing from the spirit and scope of the present disclosure. Accordingly, the scope of the present disclosure is not limited by the disclosure of the preferred embodiment. Instead, the invention should be determined entirely by reference to the claims that follow.

What is claimed is:

1. A hose comprising:
an elastic tube with a first end portion and a second end portion;
an extensible cylindrical housing with a first end and a second end, and arranged to substantially accommodate a length of the elastic tube co-axially inside thereof; and
a coupling member positioned at the first end of the extensible cylindrical housing, the coupling member having external threads adapted to allow removably attaching of an attachment device therewith,
wherein at least the first end portion of the elastic tube is extending outside of the first end of the extensible cylindrical housing and is folded over the coupling member.

2. The hose of claim 1 further comprising a clamping member arranged over the folded first end portion of the elastic tube and tightened against the coupling member underneath thereof.

3. The hose of claim 2 further comprising a cap member to cover the folded first end portion of the elastic tube and the clamping member.

4. The hose of claim 1 further comprising:
another coupling member positioned at the second end of the extensible cylindrical housing, the another coupling member having external threads adapted to allow removably attaching of an attachment device therewith,
wherein the second end portion of the elastic tube is extending outside of the second end of the extensible cylindrical housing such that the second end portion of the elastic tube is folded over the another coupling member.

5. The hose of claim 4 further comprising another clamping member arranged over the folded second end portion of the elastic tube and tightened against the another coupling member underneath thereof.

6. The hose of claim 5 further comprising another cap member to cover the folded second end portion of the elastic tube and the another clamping member.

7. The hose of claim 1, wherein the elastic tube is made of water-proof thermoplastic elastomer.

8. The hose of claim 1, wherein the elastic tube is made of triple layer latex.

9. The hose of claim 1, wherein the elastic tube is adapted to expand both longitudinally and transversely inside the extensible cylindrical housing.

10. The hose of claim 1, wherein the extensible cylindrical housing is substantially hollow to allow the length of the elastic tube to be extended therein.

11. The hose of claim 1, wherein the extensible cylindrical housing is a corrugated pipe.

12. The hose of claim 1, wherein the extensible cylindrical housing is made of non-elastic material.

13. The hose of claim 1, wherein the coupling member is made of brass material.

14. The hose of claim 1, wherein the attachment device has internal threads to mate with the external threads of the coupling member for removably attaching therewith.

15. The hose of claim 1, wherein the attachment device comprises one of an intermediary valve device, a fluid spigot device and a fluid restrictor device.

16. The hose of claim 1, wherein the attachment device comprises an intermediary valve device having openings at both ends thereof.

17. The hose of claim 16, wherein the intermediary valve device is adapted to allow removably attaching of one or more of a fluid spigot device and a fluid restrictor device therewith.

18. A leak-proofing arrangement for an elastic tube with a first end portion and a second end portion, the leak-proofing arrangement comprising:
an extensible cylindrical housing with a first end and a second end, and arranged to substantially accommodate a length of the elastic tube co-axially inside thereof; and
a coupling member positioned at the first end of the extensible cylindrical housing, the coupling member having external threads adapted to allow removably attaching of an attachment device therewith,
wherein at least the first end portion of the elastic tube is extending outside of the first end of the extensible cylindrical housing and is folded over the coupling member positioned at the first end of the extensible cylindrical housing.

19. The leak-proofing arrangement of claim 18 further comprising:
another coupling member positioned at the second end of the extensible cylindrical housing, the another coupling member having external threads adapted to allow removably attaching of an attachment device therewith,
wherein the second end portion of the elastic tube is extending outside of the second end of the extensible cylindrical housing such that the second end portion of the elastic tube is folded over the coupling member positioned at the second end of the extensible cylindrical housing.

20. The leak-proofing arrangement of claim 19 further comprising:
a clamping member arranged over the folded first end portion of the elastic tube and tightened against the coupling member underneath thereof; and
another clamping member arranged over the folded second end portion of the elastic tube and tightened against the another coupling member underneath thereof.
